(19) United States
(12) Patent Application Publication
(10) Pub. No.: US 2017/0245474 A1
(43) Pub. Date: Aug. 31, 2017

(54) A FEEDER ASSEMBLY

(71) Applicant: BIGGIN PTY LTD, Ramussen (AU)

(72) Inventor: Ryan BIGGIN, Ramussen (AU)

(21) Appl. No.: 15/515,739

(22) PCT Filed: Sep. 30, 2015
(86) PCT No.: PCT/AU2015/050592

§ 371 Date: Mar. 30, 2017

(30) Foreign Application Priority Data
Sep. 30, 2014 (AU) 2014903896
Sep. 30, 2014 (AU) 2014903897

(51) Int. Cl. A01K 39/012; A01K 5/02

(52) U.S. Cl. CPC A01K 39/0125; A01K 5/0208; A01K 5/025; A01K 39/04

(57) ABSTRACT

A feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper during use for allowing poultry and the like to access an internal space enclosed by the housing for consuming the feed retained in the pan.

### TECHNICAL FIELD

The present invention relates to a feeder adapted for feeding fowl and a drinker for supplying drinking liquid to fowl and the like. The invention particularly relates to feeding and drinking devices, apparatus or systems particularly suited to poultry, such as turkeys, chicken, geese and ducks.

### BACKGROUND ART

Animal feeders are common and come in a myriad of forms and display a wide variety of delivery methods. Whilst gravity driven feeders are known in the prior art, these feeders suffer from several shortcomings. For example one of the major issues relates to wastage of feed. Another issue is that the efficacy of feeders known in the prior art often depends on the type of feed material being used. Some feeders are only suited for feed particles which lie within a specific particle size range and do not work or become blocked and unsuitable for use when feed particles of a larger size are attempted to be dispensed. Furthermore, some feeders from the prior art are unable to shield or protect the dispensed feed from being exposed to external elements such as rain water, dust etc. Accordingly, there is at least a need to address some of these issues.

A typical watering system for a poultry house includes a water regulator which is connected to a supply of water to reduce the line pressure of the supply water. Watering lines extend from the regulator and drinkers typically depend from the bottom of the watering lines. Some prior art systems describe drinkers that include a housing having a ball valve which is operated by a pin. When the chicken pecks at an actuating pin, the pin moves the ball valve off its seat, to allow water to pass through the drinker, allowing the chicken to drink water. Whilst, sophisticated valve systems have been described in the prior art, a persistent problem with drinkers is the requirement of a main water supply line that needs to be connected to the drinking system for operation of the prior art drinker systems. Accordingly, it would be advantageous to have stand-alone drinker systems which do not need to be connected to a mains water supply line. Whilst a number of stand-alone water dispensing units are currently known all of them are plagued by problems such as leakage and corrosion of mounting parts. Stand-alone drinker systems are also complicated and cumbersome to operate.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a feeder which may at least partially overcome at least one of the abovementioned disadvantages or provide the consumer with a useful or commercial choice.

In one aspect, the invention provides a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper for allowing poultry and the like to access an internal space enclosed by the housing for consuming the feed retained in the pan, wherein at least one upstanding web is provided in the internal space of the housing and is positioned for limiting movement of poultry or the like during consumption of the feed retained in the pan.

The upstanding web may be of the form that projects outwardly in a direction from a substantially central and interior part of the housing to a substantially peripheral part of the housing. The provision of such an upstanding web limits lateral movement of the poultry accessing the internal space enclosed by the housing. This configuration is particularly effective in reducing lateral side-side head movement of poultry during consumption of the feed material retained in the pan. Thus, the upstanding web prevents the vigorous movement of the fowl during feeding and prevents the feed from being knocked out of the housing through the opening thereby reducing wastage of feed.

In some embodiments, the feeder may also comprise a feed directing device positioned for receiving feed from the hopper and directing the feed into the pan located at the bottom of the housing. This feed directing device may comprise a receiving portion that may be operable to be readily coupled with the hopper and/or the base for receiving and directing the feed material from the hopper into the pan. The upstanding web may form a part of this feed directing device.

In some embodiments, the feed directing device may include a feed directing passage for conducting the feed from the receiving portion into the pan through a feed outlet. The upstanding wall may be in the form of a projecting web extending outwardly from an outer wall of the feed directing passage. During use, the feed directing device may be positioned in an operating orientation by way of being fastened to an internal wall of the housing. Fastening the feed directing device in this manner results in the feed directing passage being positioned in a substantially central location in the interior space defined by the housing. As a result, during use, the projecting web extends from a substantially central and interior part of the housing to a substantially peripheral part of the housing.

In a second aspect, the invention provides a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper during use for allowing poultry and the like to access an internal space enclosed by the housing for consuming the feed retained in the pan, the feeder further comprising at least one upstanding retaining web extending upwardly relative to the pan and positioned adjacent the opening, the retaining web being provided in the internal space of the housing and being positioned for retaining the feed in the housing.

The feature of the retaining web avoids the feed from spilling out of the housing during use. The applicants have realised that prior art feeders often fail to contain the feed material in a feeding pan or a feeding trough, especially during feeding of the fowl/poultry. Provision of the retaining web in accordance with the second aspect addresses this issue thereby reducing wastage of the feed material.

In some embodiments, the retaining web may extend in a downwardly direction towards the pan. The retaining web may also extend from an end of the upstanding web described in the first aspect. Providing the retaining web at a distal end of the upstanding web advantageously results in the retaining web being positioned adjacent to the peripheral part of the housing and near the opening. Preferably, the respective planes of the retaining web and the upstanding webs are mutually perpendicular to each other. As a result of the positioning of the retaining web, the feed is prevented from being spilled out of the housing through the opening during use.

In a third aspect, the invention provides a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper during use for allowing poultry and the like to access an internal space enclosed by the housing for consuming the feed retained in the pan, a feed directing device for receiving the feed from the hopper and directing the received feed into the pan through a feed directing passage forming a feed outlet, wherein separation between the outlet and a bottom portion of the pan is selectively adjustable.

In this aspect, the flow of the feed from the hopper to the pan is effectively controlled by controlling the separation distance between the outlet and the bottom portion of the pan. For example, this distance needs to be greater if larger food particles are to be allowed to flow out from the feed passageway of the feed directing device onto the pan. Similarly, this distance needs to be comparatively lesser to avoid excessive flow of the feed material into the pan. Therefore, the present invention allows the feeder of the present invention to be utilised for feed material of varying sizes. This adjustment also allows for controlling the flow rate of the feed exiting the outlet.

In one embodiment, the base may comprise a connecting portion or a connecting mechanism adapted to connect a bottom portion of the housing with peripheral walls of the pan in multiple connected configurations, wherein each connected configuration results in an associated separation distance between the outlet of the feed directing device and the bottom portion of the pan. In some further embodiments, the connecting mechanism may be provided in the form of a connecting collar adapted to be fastened onto the peripheral walls of the pan and/or the lower portion of the housing. The collar may be provided with screw threads that engage with threads provided on the peripheral walls of the pan for being fastened onto the base. By twisting the connecting collar relative to the peripheral walls along the threads, the effective height at which the feed directing device is fastened (relative to the bottom portion of the pan) to the housing is varied. As a result, the separation between the device outlet and the bottom portion of the pan is also varied. By way of example, a clockwise twist imparted to the connecting collar will result in lowering of the effective height whereas an anti-clockwise twist to the connecting collar will result in an increase in the effective height.

In a fourth aspect, the invention provides a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper during use for allowing poultry and the like to access an internal space enclosed by the housing for consuming the feed retained in the pan, wherein the base includes a hood extending outwardly from an outer wall of the housing and over the opening to the housing, the hood including an upturned peripheral edge for preventing ingress of any extraneous matter positioned or accumulated on the hood into the housing from the opening.

During prolonged outdoor use of the feeder, dust and grime may accumulate on the hood and on the outer walls of the housing. Furthermore, any exposure of the feeder to rain water results in the washing away of dust and grime by rain water resulting in the possibility of extraneous matter such as rain water entering the housing from the opening that may result in the feed material becoming unsuitable for consumption. Providing the hood with an upturned edge portion in this aspect of the invention prevents the entry of rain water (and any dust grime or other extraneous matter mixed with rainwater) into the housing. The upturned edge portion forms a flow directing gutter and directs the flow of rain water away from the opening of the housing.

In at least some embodiment, the hood is substantially arcuate or semi-circular in shape and may further comprise one or more curved portions connected with the upturned peripheral edge for further directing the extraneous matter further away from the opening.

In a fifth aspect, there is provided a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further comprising a housing for at least enclosing the pan, the housing including an opening positioned in between the pan and the hopper during use for allowing poultry and the like to access an internal space enclosed by the housing for consuming the feed retained in the pan, a feed directing device positioned for receiving the feed from the hopper and directing the received feed into the pan, wherein the food directing device is configured to be coupled to the hopper and/or the housing in no more than one coupled orientation.

In at least some embodiments, the receiving portion of the feed directing device includes a plurality of engagement projections which are adapted to inter-engage with the housing. At least one of the engagement projections provided in the form of a locating lug is sized to be received into a corresponding notch provided on an upper portion of the housing. The notch is positioned for ensuring that the feed directing device is seated in the housing in an appropriate orientation thereby allowing the feed to be directed from the hopper to the pan. It is important to appreciate that the positioning of the feed directing device (which may be easily removable for disassembly and/or maintenance) within the housing is very important for ensuring the proper functionality of the feeder by way of positioning the feed directing device relative to the housing. Advantageously, the aforementioned configuration does not allow the feed directing device to be seated in the housing until the lug is located in the notch. Therefore, provision of the aforementioned lug and the corresponding notch thereby ensures that the feed directing device is always seated in a correct orientation, thereby also providing a useful aid to the skilled user for assembling the feeder device easily.

In a sixth aspect, the invention provides a feeder for feeding poultry and the like, the feeder comprising: a base including a pan configured to receive and retain feed; a storage hopper positioned above the base during use for receiving and storing feed, said hopper being operable to dispense feed into the pan under the effect of gravity; the base further including a housing for at least enclosing the pan, the housing including an opening positioned in between the pan and the hopper during use for allowing poultry and the like to access an internal space enclosed by the housing for consuming the feed retained in the pan, wherein the housing is configured to be coupled to the hopper in no more than one coupled orientation.

Preferably, the housing comprises a upper portion positioned for alignment and engagement with a skirted end of an outer wall portion of the storage hopper such that at least three locking members are provided on one of the connecting member or the skirted end and at least three corresponding inter-locking members are provided on the other of the skirted end or the connecting member respectively such that during use, the locking members engage with the inter-locking members to inter-lock the connecting member with the skirted end thereby coupling the housing with the storage hopper.

In some embodiments, angular spacing in between the at least three locking members is unequal and as a result, the angular spacing in between the inter-locking members is also correspondingly unequal thereby preventing the coupling of the housing and the hopper in more than the one coupled orientation. The angular spacing referred to herein is generally with reference to an imaginary centrally positioned vertical axis of the storage hopper and/or the housing.

Alternatively or additionally, the locking members may be spaced at non-uniform intervals along a circular periphery (circumference) of the upper portion of the housing or the skirted end of the hopper. Positioning the locking members and the corresponding inter-locking members along the circumference of the upper and the skirted end respectively at the unequal intervals results in unequal angular spacing of the locking members.

One of the significant advantages of providing a housing and a storage hopper which can only be coupled in one coupling orientation with the locking members being positioned at unequal angular spacing or unequal circumferential intervals is that a visual means is available for enabling users to easily detect the requisite rotational orientation of the housing relative to the storage hopper in order to prevent the incorrect alignment of these portions of the casing.

In a seventh aspect, there is provided a feeder for feeding poultry and the like, the feeder comprising: a base comprising a pan configured to receive and retain feed; a storage hopper positioned above the base portion for receiving and storing feed, said hopper operable to dispense feed into the pan under the effect of gravity; the base further comprising a housing for at least enclosing the pan, the housing including an opening positioned in between the pan and the hopper for allowing poultry and the like to access an internal space enclosed by the housing for consuming the feed retained in the pan, and at least one fastener for fastening the housing and/or the storage hopper onto a support, wherein during use, the fastener maintains the housing and/or the storage hopper in a substantially vertical orientation relative to each other thereby allowing the hopper to dispense feed into the pan under gravity.

In some embodiments, the fasteners function as a supporting member for fastening and supporting the feeder onto a supporting surface or a supporting structure. For example, the fastener may take the form of a hook or a clip that is adapted to mount the reservoir onto a supporting surface of a structure such as a wall. In other embodiments, the fastener may be adapted for mounting the reservoir onto other supporting structures such as a fence.

In some embodiments, the hook may comprise a hook body that is adapted to hook onto the supporting surface or the supporting structure thereby mounting the reservoir to the supporting surface or supporting structure, the hook including a receiving portion for receiving at least a part of the supporting structure or supporting surface. For example, the supporting structure or the surface may be received in a space defined by the receiving portion and a part of the upstanding wall.

Advantageously, the aforementioned hook may also comprise an end portion positioned at a free end of the hook-body wherein the end portion extends in an outward direction away from the upstanding wall of the container. Providing such an outwardly extending flanged configuration is particularly advantageous in that it enables the easy hooking and unhooking of the hook onto the supporting structure.

In some further embodiments, the hook body may be attached to an outer wall of the housing and/or the storage hopper on a profiled rib. The rib is advantageously profiled to maintain the hook body in a position relative to the supporting surface or the supporting structure such that the storage hopper and the hosing remain in a substantially vertical configuration as mentioned above.

In some embodiments, the hopper may comprise walls defining an interior space for storing the feed. The walls may be comprised of non-opaque or translucent or semi-transparent or transparent material. Providing such walls allows users to view and monitor the level of feed contained in the hopper from a viewable distance without having to remove the lid of the hopper thereby alleviating the need to constantly open the lid of the hopper to check the feed levels in the hopper to ascertain if the feed needs to be replenished or replaced.

According to yet a further embodiment, the present invention in one aspect, resides broadly in a drinker assembly for supplying drinking liquid, the apparatus comprising: a reservoir including a base and upstanding walls, the base and the walls defining an internal volume for holding the liquid therein; an outlet port extending through said reservoir to allow the liquid to exit said reservoir under gravitational effect and be received into a receptacle; a valve assembly positioned in fluid communication with the outlet port for controlling flow of the liquid from the reservoir to the receptacle; at least one supporting member adapted to support said reservoir at an elevated position relative to the receptacle to enable flow of the liquid under gravitational effect from the reservoir to the receptacle wherein the supporting member is integrally formed with the upstanding walls of the reservoir.

The drinker assembly of the present invention is particularly adapted to supplying drinking liquid to fowl such as chickens, duck, geese and the like but it will be readily recognised by a person of skill in the art that the drinker assembly can also be used to supply drinking liquid small domestic animals such as rabbits, cats, dogs and the like.

The drinker assembly of the present invention relies on flow of the drinking liquid such as water under the effect of gravity from the reservoir to the receptacle. The orientation of the reservoir relative to the receptacle is therefore of substantial importance. Assembling the drinker assembly preferably requires the receptacle to be stationed at a position so that fowl are able to easily access the drinking liquid. For example, the receptacle may be positioned on the ground level to enable easy access by fowl etc. However, in order to maintain gravitational flow of the liquid from the reservoir, the reservoir needs to be positioned at a relatively higher vertical height relative to the receptacle. In prior art systems, this elevated positioning is achieved by attaching the reservoir to a supporting structure such as a fence or a wall. In order to do so, metallic mounting brackets are generally used by prior art systems to secure the reservoir at a relatively greater height (at an elevated position). Installation of such brackets can be cumbersome. Furthermore, such metallic brackets are also prone to corrosion that may prevent prolonged use. The present invention outlined in the first aspect addresses some of these problems by providing a supporting member which is integrally formed with the walls of the reservoir thereby alleviating the need for additional metallic brackets. Providing integrally formed supporting members such as hooks and/or clips etc. has a substantial effect on the working of the invention in that it enables easy installation of the drinker assembly whilst also preventing the use of additional externally mounted brackets which require procedures such as drilling etc. Such integrally formed supporting members are also not susceptible corrosion and subsequent failure.

In some embodiments, the supporting member comprises one or more fasteners for fastening the reservoir onto a supporting surface or a supporting structure. For example, the fastener may take the form of a hook or a clip that is adapted to mount the reservoir onto a supporting surface of a structure such as a wall. In other embodiments, the fastener may be adapted for mounting the reservoir onto other supporting structures such as a fence.

In some embodiments, the hook may comprise a hook body that is adapted to hook onto the supporting surface or the supporting structure thereby mounting the reservoir to the supporting surface or supporting structure, the hook including a receiving portion for receiving at least a part of the supporting structure or supporting surface. For example, the supporting structure or the surface may be received in a space defined by the receiving portion and a part of the upstanding wall.

Advantageously, the aforementioned hook may also comprise an end portion positioned at a free end of the hook- body wherein the end portion extends in an outward direction away from the upstanding wall of the container. Providing such an outwardly extending flanged configuration is particularly advantageous in that it enables the easy hooking and unhooking of the hook onto the supporting structure.

In another aspect, the invention provides a drinker assembly for supplying drinking liquid to poultry or the like, the assembly comprising: a reservoir including a base and upstanding walls, the base and the walls defining an internal volume for holding the liquid therein; an outlet port extending through said reservoir to allow the liquid to exit said reservoir under gravitational effect and be received into a receptacle; a valve assembly positioned in fluid communication with the outlet port for controlling flow of the liquid from the reservoir to the receptacle; the reservoir further comprising a removable lid for introducing the liquid into the reservoir and/or for accessing the internal volume of the reservoir, the assembly further comprising a locking mechanism operable for locking the lid onto the reservoir to prevent removal of the lid from the reservoir.

Providing a removable lid that is configured to be locked to the reservoir provided several advantages. The lid prevents the ingress of dirt, grime germs etc. into the liquid contained in the reservoir. Whilst, the provision of lids for reservoir in the form of housings or hoppers has been previously known, the present applicant has realised that providing a locking arrangement to secure the lid to the casing is highly advantageous in that it prevents the inadvertent removal of the lid. The lid is only removable by unlocking the locking mechanism to access the casing for purposes such as cleaning or other maintenance tasks. Preferably, the lid also provides a convenient carry handle that locks to also prevent spillage of water.

In some embodiments, the locking mechanism comprises at least one flange on either the reservoir or the lid and at least one corresponding projection on either the lid or the reservoir respectively, the flange and projection being arranged such that, during use the flange engages with the projection thereby locking the lid onto the walls of the reservoir. The description in the foregoing sections discusses a particular embodiment in which the flange is provided on the removable lid and the projection is provided on an upper rim of the casing that engages with the lid. A skilled person would readily appreciate, that the benefits of the present invention may also be realised by providing the flange on the reservoir and the projections on the removable in an alternative configuration without departing from the spirit and scope of the invention.

In yet another aspect, the invention provides a drinker assembly for supplying drinking liquid to poultry or the like, the assembly comprising: a reservoir including a base and upstanding walls, the base and the walls defining an internal volume for holding the liquid therein; an outlet port extending through said reservoir to allow the liquid to exit said reservoir under gravitational effect and be received into a receptacle; a valve assembly positioned in fluid communication with the outlet port for controlling flow of the liquid from the reservoir to the receptacle; the reservoir further comprising a removable lid for introducing the liquid into the reservoir and/or for accessing the internal volume of the reservoir wherein the lid comprises a handle for holding the lid during use.

Providing a handle for lifting the lid presents a significant advantage in enabling the easy removal of the lid if and when necessary. The handle is especially helpful in embodiments which include the locking mechanism of the previously discussed aspect. For example, unlocking the locking mechanism that includes the flanges and the projection may require an application of a pulling force to disengage the projections from the flange. Provision of a handle assists in advantageously applying this pulling force to unlock the lid from the housing.

In another aspect, the invention provides a drinker assembly for supplying drinking liquid to poultry or the like, the assembly comprising: a reservoir comprising a base portion and an upstanding wall portion, the base and the wall portions defining an internal volume for holding the liquid therein; an outlet port extending through said reservoir to allow the liquid to exit said reservoir under gravitational effect and be received into a receptacle; a valve assembly positioned in fluid communication with the outlet port for controlling flow of the liquid from the reservoir to the receptacle; and an elastomeric sealing member such that during coupling of the base portion with the wall portion, respective sealing surfaces provided on the base portion and the wall portion engage with the elastomeric sealing member thereby securing a seal between the base portion and the wall portion of the reservoir.

The tendency of the elastomeric member to maintain its original shape creates the seal between the base portion and the wall portion. In some embodiments, the elastomeric member may take the form of an O-ring. During use, as the elastomeric member is deformed when the sealing surfaces are brought together, the elastomeric member exerts a force against the sealing surfaces equal to the force it takes to deform the elastomeric member. The areas of contact between the elastomeric member and the respective sealing surfaces act as a barrier to block the leakage of the drinking fluid from the reservoir during use. Providing the sealing member in a circular cross section in at least some embodiments provides minimum sealing surface exposure, which enhances resistance to abrasion, fluids, adverse environments, and arid mechanical damage. The circular cross section is also appealing because it is adaptable to axial, radial, or angular deformation. Furthermore, the use of the elastomeric member also alleviates the need for using sealing adhesives to seal the base portion and the wall portion, thereby making assembly of these drinker assemblies relatively simple.

In other embodiments, the base portion may be attached to, onto or relative to the wall portion using other mechanisms such as adhesives or threads or the like.

In yet another aspect, the invention provides a drinker assembly for supplying drinking liquid to poultry or the like, the assembly comprising: a reservoir comprising a base portion and an upstanding wall portion, the base and the wall portions defining an internal volume for holding the liquid therein; an outlet port extending through said reservoir to allow the liquid to exit said reservoir under gravitational effect and be received into a receptacle; a valve assembly positioned in fluid communication with the outlet port for controlling flow of the liquid from the reservoir to the receptacle; and wherein the base portion and the wall portion are configured to be aligned and coupled to each other in no more than one coupled orientation.

Preferably, the base portion comprises a connecting portion positioned for alignment and engagement with a skirted end of the wall portion such that at least three locking members are provided on either the connecting member or the skirted end and at least three corresponding engagement members are provided on the on either the skirted end or the connecting member respectively such that during use, the locking members engage with the engagement members to inter-lock the connecting member with the skirted end thereby coupling the base portion with the wall portion.

In some embodiments, angular spacing in between the at least three locking members is unequal and angular spacing in between the engagement members is also correspondingly unequal thereby preventing the coupling of the base portion and the wall portion in more than the one coupled orientation. The angular spacing referred to herein is generally with reference to an imaginary centrally positioned vertical axis of the reservoir.

Alternatively or additionally, the locking members may be spaced at non-uniform intervals along a circular periphery (circumference) of the connecting member or the skirted end. Positioning the locking members and the corresponding engagement members along the circumference of the connecting member and the skirted end at unequal intervals results in unequal angular spacing of the locking members.

One of the significant advantages of providing a reservoir in which the base and the wall portions can only be coupled in one coupling orientation with the locking members being positioned at unequal angular spacing or unequal circumferential intervals is that a visual means is available for enabling users to easily detect the requisite rotational orientation of the base portion relative to the upstanding wall in order to prevent the incorrect alignment of these portions of the casing.

In some embodiments, the upstanding walls of the reservoir may be comprised of non-opaque or translucent or semi-transparent or transparent material. Providing such upstanding walls allows users to view and monitor the level of water contained in the reservoir from a viewable distance without having to remove the lid of the reservoir thereby alleviating the need to constantly open the lid of the reservoir to check the water levels in the reservoir to ascertain if the water needs to be replenished or replaced.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a perspective view of a first embodiment of a feeder in an assembled configuration in accordance with the present invention.

FIG. 2 is an exploded view of the first embodiment of the feeder.

FIG. 3 is first perspective view of the feed directing device in the first embodiment.

FIG. 4 is a first side view of the feed directing device in the first embodiment.

FIG. 5 is a second side view of the feed directing device in the first embodiment.

FIG. 6 is a top view of the feed directing device in the first embodiment.

FIG. 7 is second perspective view of the feed directing device in the first embodiment.

FIG. 8 is a first perspective view of the base in the first embodiment.

FIG. 9 is a first side view of the base of the first embodiment.

FIG. 10 is a front view of the base of the first embodiment.

FIG. 11 is a top-down view of the base of the first embodiment.

FIG. 12 is a second perspective view of the base in the first embodiment.

FIG. 13 is a first side view of a connecting collar in the first embodiment.

FIG. 14 is a second side view of the connecting collar in the first embodiment.

FIG. 15 is a top view of the connecting collar in the first embodiment.

FIG. 16 is a perspective view of the connecting collar in the first embodiment.

FIG. 17 is a first side view of the upstanding walls of the pan in the first embodiment.

FIG. 18 is a second side view of the upstanding walls of the pan in the first embodiment.

FIG. 19 is a top view of the upstanding walls of the pan in the first embodiment.

FIG. 20 is a perspective view of the upstanding walls of the pan in the first embodiment.

FIG. 21 is a sectional view of the feed flow adjustment mechanism in the first embodiment.

FIG. 22 is a first perspective view of a drinker assembly in accordance with an embodiment of the present invention.

FIG. 23 is a second perspective view of the drinker assembly in accordance with an embodiment of the present invention.

FIG. 24 is a perspective view of a tubular wall portion forming a part of the drinker assembly in accordance with an embodiment of the present invention.

FIGS. 25A-25D represent a top view, a first side view, a second side view and a second top view of the tubular wall portion respectively in accordance with an embodiment of the present invention.

FIG. 26 is an enlarged view of a supporting hook provided on the tubular wall portion in accordance with an embodiment of the present invention.

FIG. 27 is a perspective view of a lid of the drinker assembly in accordance with an embodiment of the present invention.

FIG. 28 shows an enlarged view of a locking arrangement of the drinker assembly in accordance with an embodiment of the present invention.

FIGS. 29A-29D represent a top view, a first side view, a second side view and a bottom view of the lid in accordance with an embodiment of the present invention.

FIG. 30 is an enlarged view of a coupling arrangement of the drinker assembly in accordance with an embodiment of the present invention.

FIG. 31 is a top view of base of the drinker assembly in accordance with an embodiment of the present invention. Insets B and C represent enlarged sections of the base.

### DESCRIPTION OF EMBODIMENTS

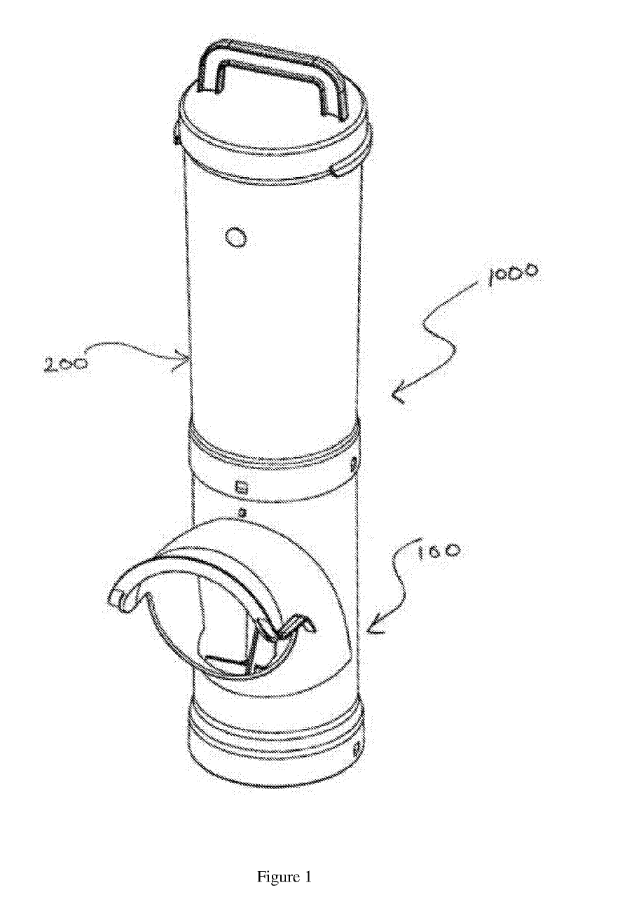

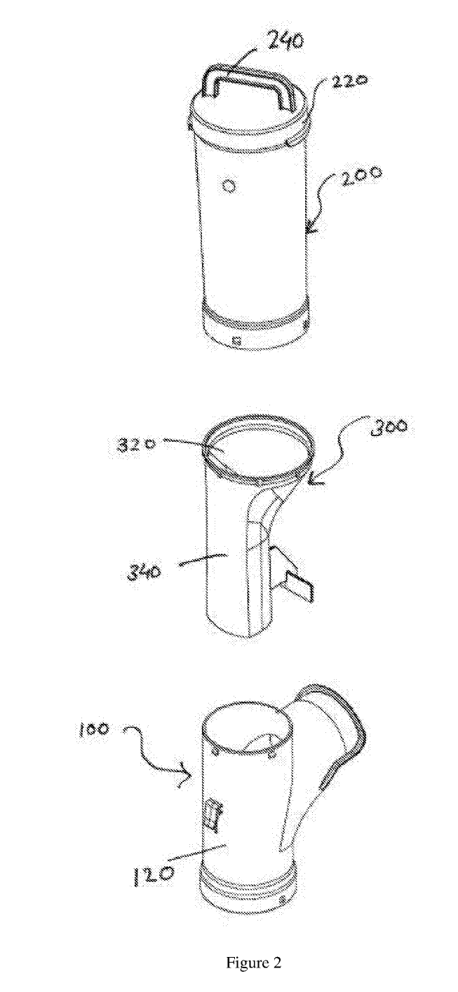

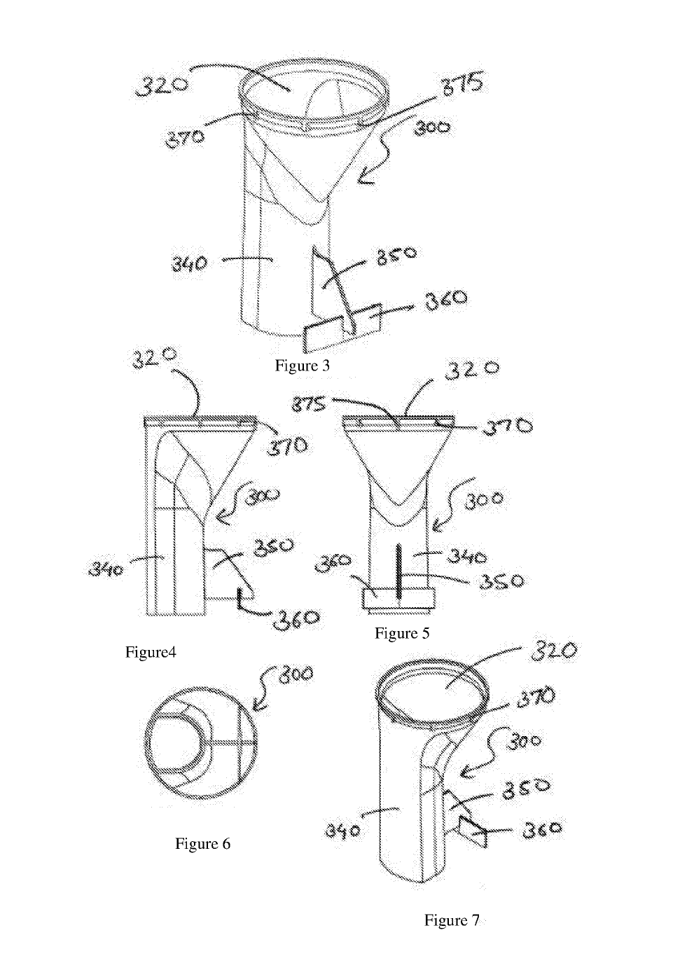

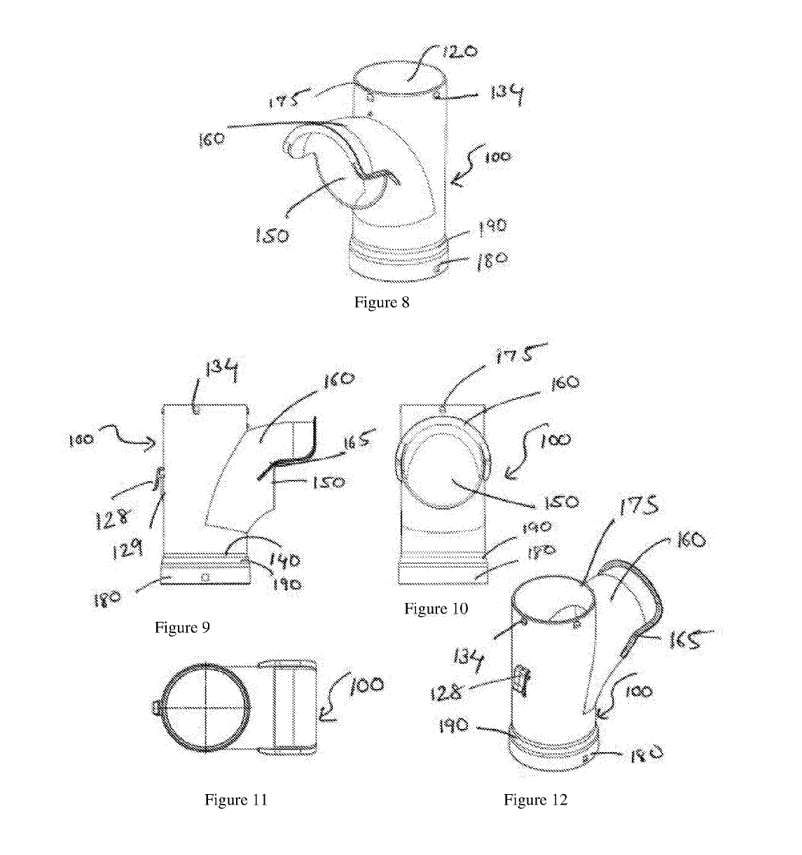

### FIGS. 1 to 21

Referring to FIGS. 1 to 5 a first non-limiting embodiment of a feeder 1000 in accordance with the invention is illustrated. The feeder 1000 can be readily assembled into an assembled configuration as shown in FIG. 1. The feeder comprises a base 100 that is located directly below a hopper 200 when assembled. The hopper 200 is in the form of a cylindrical container with upstanding walls that defines a storage space for receiving and storing the feed. The hopper 200 includes a lid 220 that is removable by gripping the handle 240 for accessing the storage space in the hopper 200. Typically, a user may undo the lid 220 to replenish feed in the storage hopper 200. The lid 220 is also useful in preventing entry of any extraneous or undesirable matter into the hopper 200. A locking mechanism may be provided to secure the lid to the hopper 200.

A feed directing device in the form of a feed directing funnel 300 is positioned for directing the feed from the hopper 200 into the base 100. The feed directing funnel 300 may be locatable either in an internal space within the storage hopper 200 or within a housing 120 defining an interior space of the base 100. In the presently illustrated embodiment, the feed directing funnel is locatable in the housing 120. A feed receiving mouth 320 with a diameter which is substantially similar to the diameter of the cylindrical storage hopper 200 is located directly below the hopper 200. The funnel 300 is of a convergent configuration and converges to form a feed directing passage 340. During use, the feed receiving mouth 320 of the funnel 300 receives the feed from the hopper 200 and conveys the feed into the housing 120 through the conducting passage 340 which may be considered to be analogous to a stem of a conventional funnel. The outer walls of the feed receiving mouth 320 are provided with a plurality of projections 370 for engaging with the housing 120 and securely seating the funnel 300 into the housing 120. These projections 370 are circumferentially spaced around the circular mouth 320 of the funnel 300. One of these engagement projections is provided in the form of a locating lug 375 which is sized to be received into a corresponding locating notch 175 provided on an upper portion of the housing 120. The notch 175 is positioned for ensuring that the feed directing funnel 300 is seated in the housing in an appropriate vertical orientation for allowing the feed to be directed from the hopper 200 to the pan at the bottom of the housing. Providing the locating lug 375 which is adapted to only fit into the locating notch 175 ensures that the feed directing funnel 300 is always seated in a correct orientation and in no more than coupled configuration, thereby also providing a useful aid to the skilled user for assembling the feeder device easily.

In order to assemble the feeder, the housing 120 needs to be coupled to the storage hopper 200. Typically this coupling step is carried out after the feed directing funnel 300 is seated in the correct orientation within the housing 120. A bottom portion of the storage hopper 200 in the form of a skirted end which is adapted for being connected with an upper portion of the housing 120 as clearly illustrated in FIG. 1. Four circumferentially spaced locking projections 134 are provided on the upper portion of the housing 120 that are adapted to be received in correspondingly positioned locking apertures 232 provided on the skirted end of the hopper 200. The locking projections 134 are arranged in a configuration such that the angular spacing in between the locking projections 134 is unequal. Such a configuration allows the base 100 and the hopper 200 to be only coupled in one coupling orientation and ensures that a leak proof seal is established. Once again, this configuration provides a visual aid to users to couple the housing and the hopper in the optimum orientation.

The base 100 comprises a pan 140 that is positioned for receiving and holding feed that passes through the feed directing funnel 300. The housing 120 forms a covered internal space for holding the feed and stops the feed from being exposed to extraneous matter such as dust, mud and rain. Advantageously, the housing 120 also comprises a circular opening in the form of a feeding window 150 which is suitably sized for allowing fowl to access the feed present in the pan 140 by inserting their head and necks into the feeding window 150 to ingest the feed within the housing without any feed being lost due to wastage. An outwardly extending arcuate hood 160 extends over the feeding window 150 and prevents the ingress of any rain water from entering the housing 120. The peripheral edge of the hood (which is located at a distal end relative to the housing 120) includes an upturned peripheral edge that prevents ingress of any extraneous matter positioned or accumulated on the hood into the housing from the opening. The upturned edge is particularly helpful in stopping any rain water from running off the edges of the hood and entering the housing 120. The upturned edges direct any rain water away from the opening and towards the either lateral ends of the hood 160 thereby acting as a gutter for directing water away from the opening. At either end of the hood 160 curved portions 165 are also provided to further direct the flow of water away from the opening and along the outer wall of the housing 120.

The feeder 1000 is also provided with a waste reducing mechanism which comprises of mutually perpendicular wall structures adapted to prevent feed material from falling out of the housing 120. These wall structures include a vertically oriented web 350 and a horizontally oriented web 360. In an assembled configuration, the vertical web 350 projects outwardly in a direction from a substantially central and interior part of the housing 120 to a substantially peripheral part of the housing 120. The vertical web 350 is configured in the shape of a truncated triangle with a downwardly increasing taper, the downwardly direction being towards the pan located at the bottom portion of the base 100. In the presently illustrated embodiment, the vertical web 350 is formed as a projection along an outer wall the feed conducting passage 340. During use, the vertical web 350 is positioned to be projecting outwards towards the feeding window 150. During use, the upstanding wall formed by the vertical web 350 limits lateral movement of the poultry accessing the internal space enclosed by the housing. This configuration is particularly effective in reducing lateral side-side head movement of poultry during consumption of the feed material retained in the pan. The vertical web 350 prevents vigorous movement of the head by poultry during feeding thereby the feed from being knocked out from the housing. Therefore, providing the vertical web 350 reduces wastage. A horizontally oriented web 360 is also positioned at one end of the vertical web 350. The horizontally oriented web 360 is positioned adjacent the feeding window 150 extends as a retaining wall to retain any feed that may otherwise be dragged out of the feeding window 150 by fowl during feeding. In order to do so, the effective web height of the horizontal web needs to be sufficiently high and at least higher than the lowermost point on the feeding window 150 to fulfil the function of retaining feed within the housing 120. The mutually perpendicular orientation of the vertical web 350 and the horizontal web 360 may also be considered to be in a T-shaped configuration having a shape similar to that of an aircraft's T-shaped tail fin as shown in FIGS. 3-7.

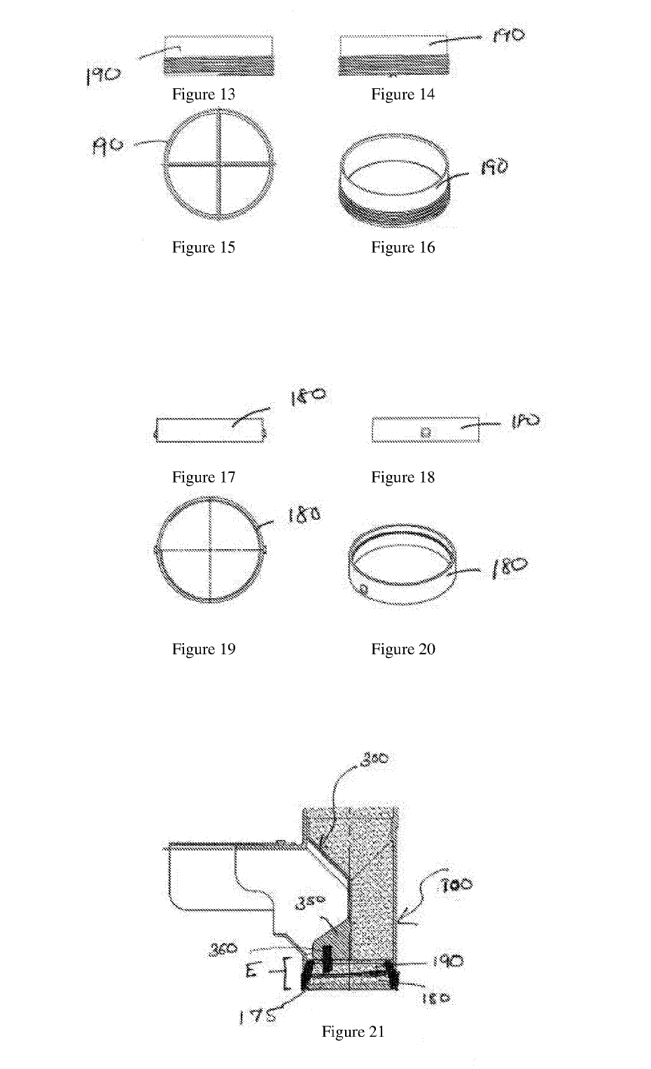

Turning to FIGS. 13-21, an feed flow adjustment mechanism is provided for adjusting the wherein separation between the outlet of the feed directing funnel 300 and a bottom portion 175 of the pan receiving the feed from the feed directing funnel 300. A connecting portion in the form of a connecting collar 190 is provided for connecting the bottom portion 175 of the pan with the housing 120. The connecting collar 190 is provided with screw threads provided along its peripheral walls and can be threaded onto upstanding walls 180 of the pan which are also provided with complementary screw threads. Twisting the connecting collar 190 in a clock-wise manner results in at least a part of the upstanding walls 180 being received in the collar 190. Similarly twisting the collar 190 in an anti-clockwise manner results in the received portion of the upstanding walls 180 being withdrawn from the collar 190. The twisting of the connecting collar therefore results in adjustment of the effective separation (E) between the bottom portion of the pan and the outlet of the conducting passage 340. By twisting the connecting collar 190 relative to the peripheral upstanding walls 180, along the threads, the effective height at which the feed directing device is fastened (relative to the bottom portion of the pan) to the housing is varied. As a result, the separation between the device outlet and the bottom portion of the pan is also varied. By way of example, a clockwise twist imparted to the connecting collar will result in lowering of the effective vertical height whereas an anti-clockwise twist to the connecting collar will result in an increase in the effective height.

During a typical installation in a poultry house, the storage hopper is desirably positioned above ground level to ensure that the feeding window 150 is positioned within easy access of fowl roaming the poultry facility. As discussed, the feeder 1000 relies on flow of the feed under the effect of gravity from the hopper 200 to the base 100. The orientation of the hopper 200 relative to the housing 120 is therefore of substantial importance. In order to maintain the gravitational at least the hopper 200 and an upper portion of the housing 120 needs to be positioned at an elevated position relative to the pan which forms the bottom portion of the base. It is also important to ensure that the hopper 200 and/or housing 120 is adequately supported at the elevated position. Advantageously, an outer wall of the housing is provided with mounting hooks 128 that are integrally moulded into the outer walls of the tubular portion 124 thereby alleviating the need for additional metallic brackets or other non-integral mounting arrangements. Each hook 128 is advantageously connected to the outer wall of the tubular portion 124 at two distinct connecting positions. A profiled rib 129 is formed on the outer wall of the housing 120 that provides the connecting positions for the mounting hook 128. The hook 128 comprises a receiving portion that together with a small part of the outer wall of the housing 120 receives a supporting fixture mounted on a wall or a pillar and thereby mounting the housing 120 onto the supporting fixture. The hook 128 also includes a free end which extends outwardly and is curved or bent outwards away from the outer wall of the housing 120 to enable easy mounting and dismounting of the housing 120. In some other alternative embodiments, other types of fasteners or fastening mechanisms may also be integrally moulded with the outer walls of the housing 120 for mounting the housing on supporting fixtures as described herein. Providing integrally formed hooks 128 thus enables easy installation of the feeder 1000 whilst also preventing the use of additional externally mounted brackets.

Whilst the feeder described herein is particularly suited for fowl, a person skilled in the art would recognise that the drinker may be utilised for supplying feed to other animals such as but not limited to dogs, cats, rabbits, guineapigs etc.

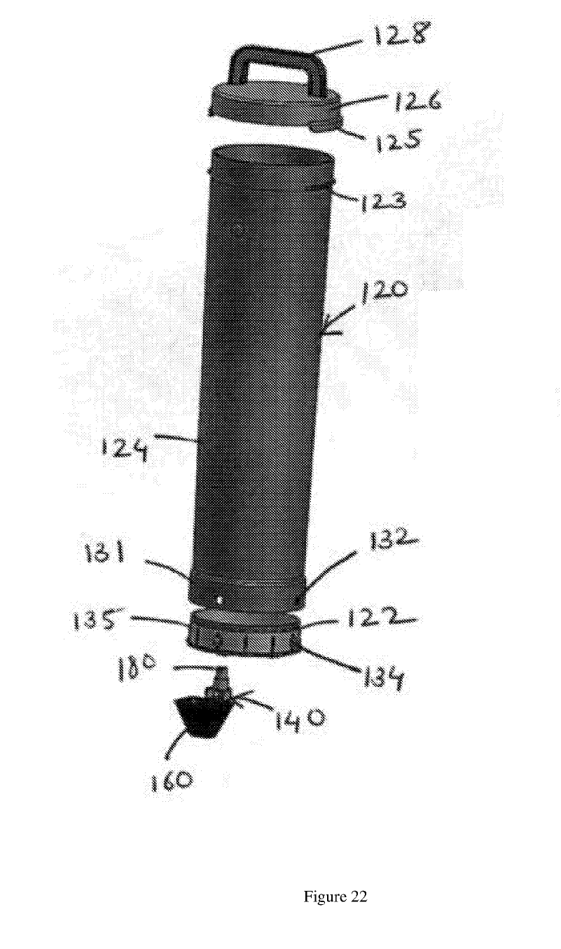

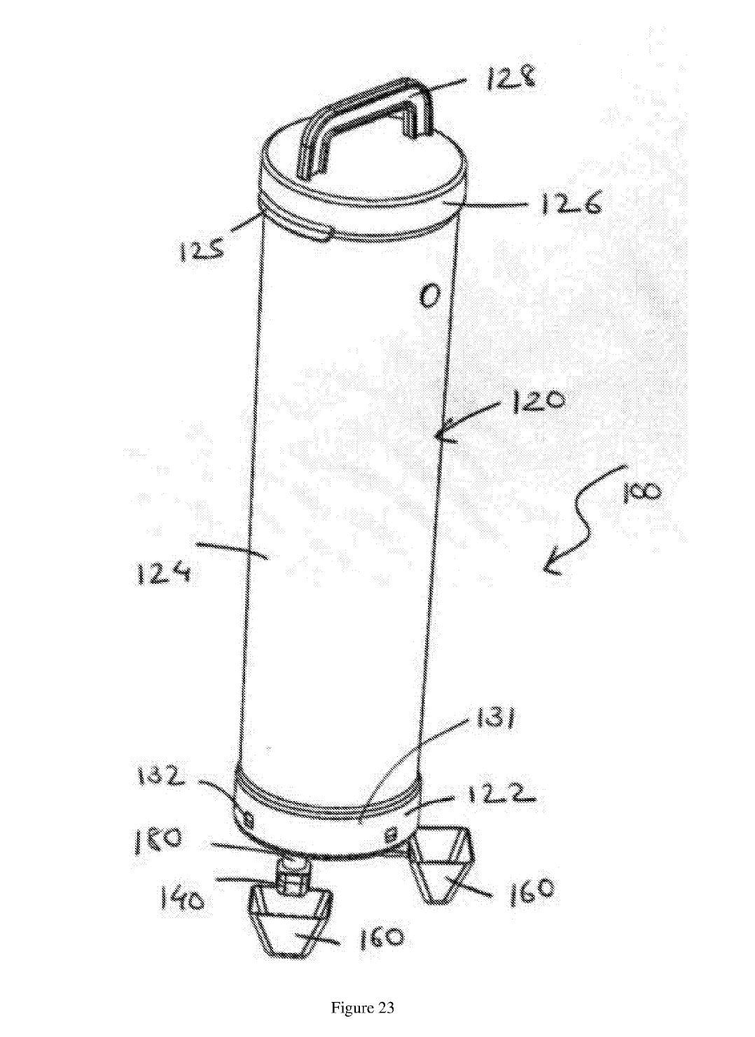

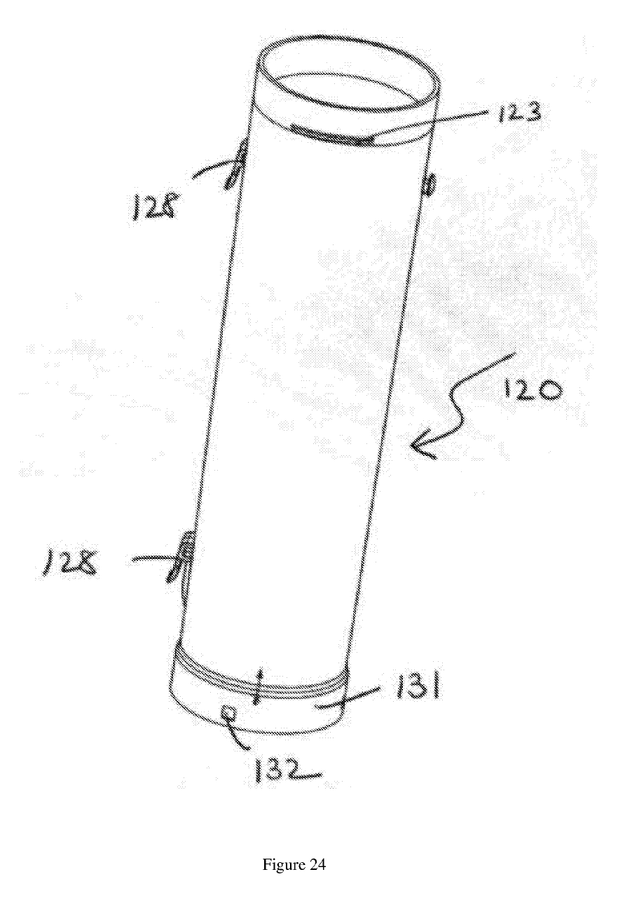

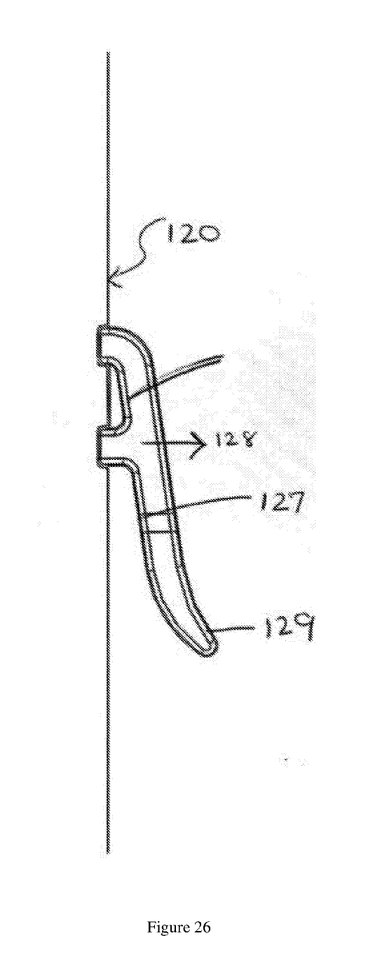

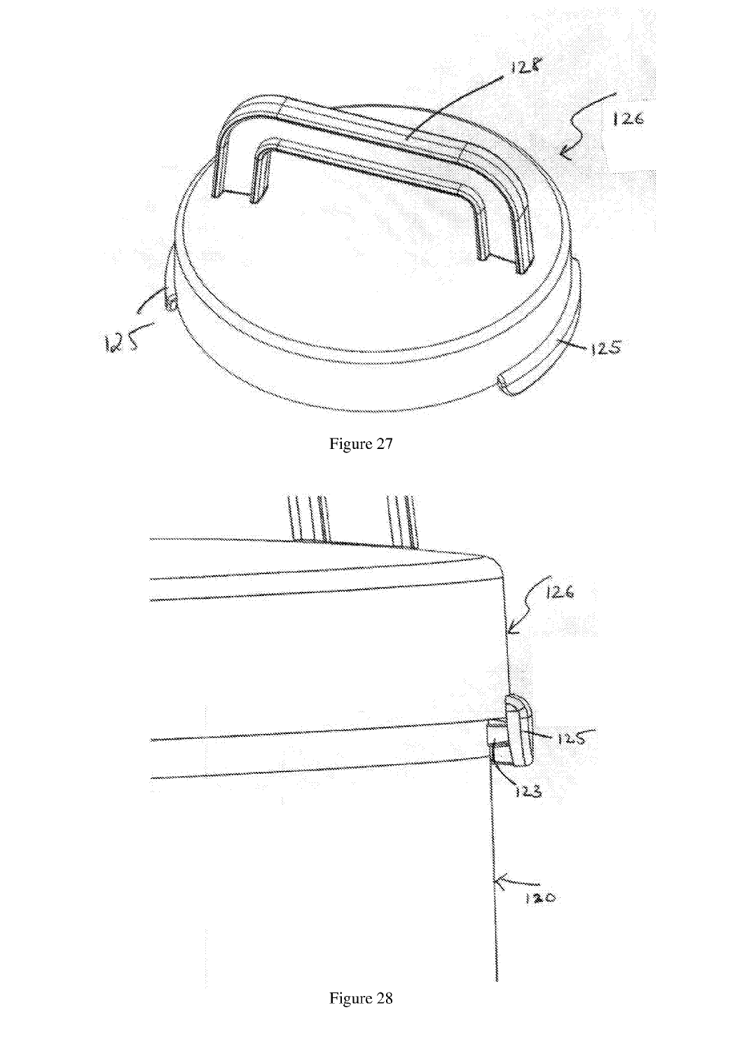

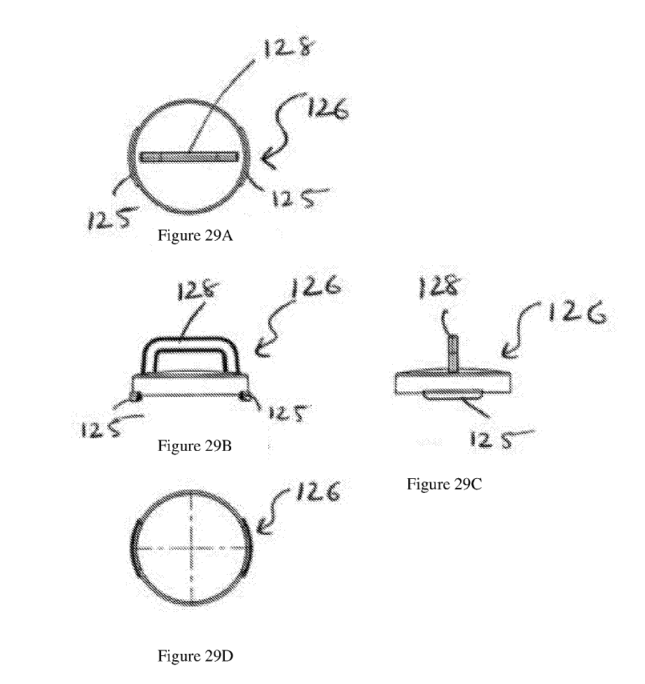

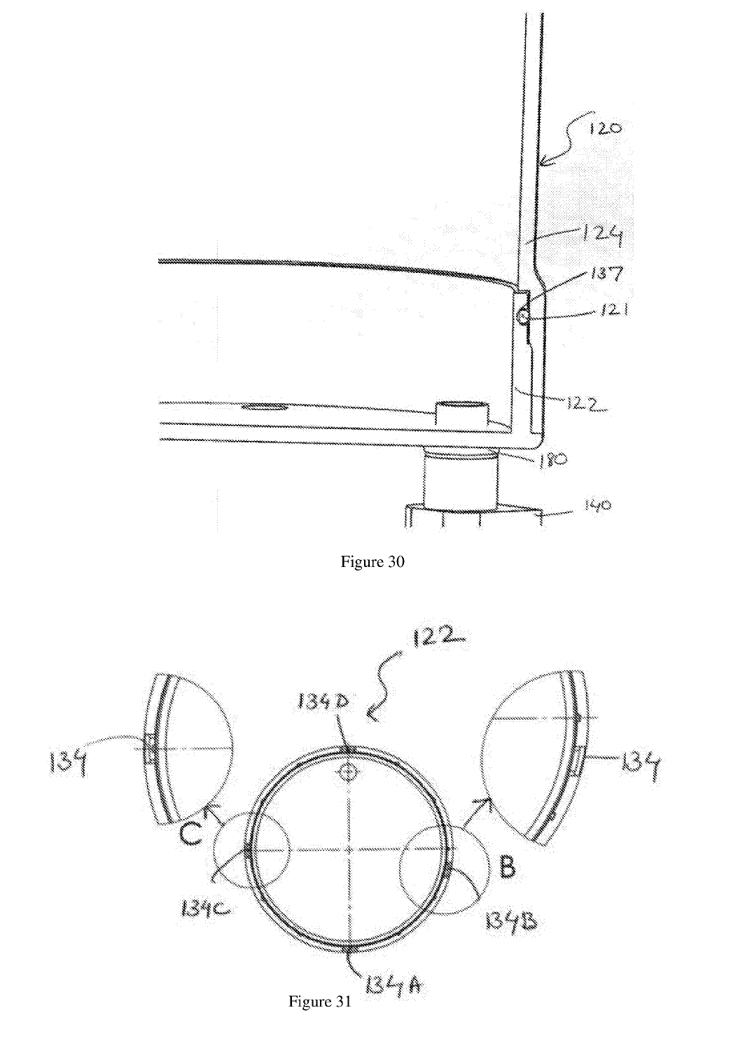

### FIGS. 22 to 31

The drinker assembly 100 described in FIGS. 22 to 31 comprises an elongate and tubular housing 120 that provides a reservoir for containing a drinking liquid such as water within its internal volume. The housing 120 is preferably provided in a two-part configuration and can be readily assembled by coupling the base 122 and a tubular portion 124. The tubular portion 124 with its upstanding walls when coupled with the base 122 provides a hollow internal housing which is adapted to hold the drinking liquid such as water. The base 122 and the tubular portion 124 may be manufactured from injection moulded material such as UV-resistant Poly Vinyl Chloride (PVC). In further embodiments, other suitable materials may also be utilised for manufacturing the housing 120. An outlet port 180 is positioned in the base 122 for allowing the drinking liquid to flow out of the housing 120 under gravitational force. It is readily apparent that the outlet port 180 may alternatively be positioned on the tubular portion 124 to also allow the flow of drinking liquid out of the housing 120. Drinking valve 140 is positioned in fluid communication with the outlet port 180 for controlling flow of the liquid from the housing 120 into a receptacle in the form of a drinking trough 160. Advantageously, the drinking trough 160 is positioned in close proximity to the ground level to enable fowl to readily access water contained in the trough. The drinking valves 140, which are preferably of the same design as one another, have a valve pin, which projects out of the valve housing at the bottom by way of an actuating end. The respective drinking valve 140 may be opened by the valve pin being pivoted at least once from the actuating end, as a result of which water is allowed to flow out from the housing 120 into the trough 160 as a result of which the trough fills up with water. Typically, the actuating end is readily accessible by poultry thereby allowing the birds to actuate the valve by pecking at the actuating end. If actuation of the valve pin ceases, the drinking valve 140 closes automatically, as a result of which further flow of water out of the drinking valve 140 is interrupted. The trough 160 and the valve 140 are directly mounted to a bottom under-surface of the base 122 which enables the gravitational flow of the drinking liquid into the water trough 160 when the valve 140 is actuated by the pecking of fowl. It is to be appreciated that more than one outlet port 180 may also be provided for positioning two or more troughs 160 that may be adapted to receive the drinking fluid from the housing 120.

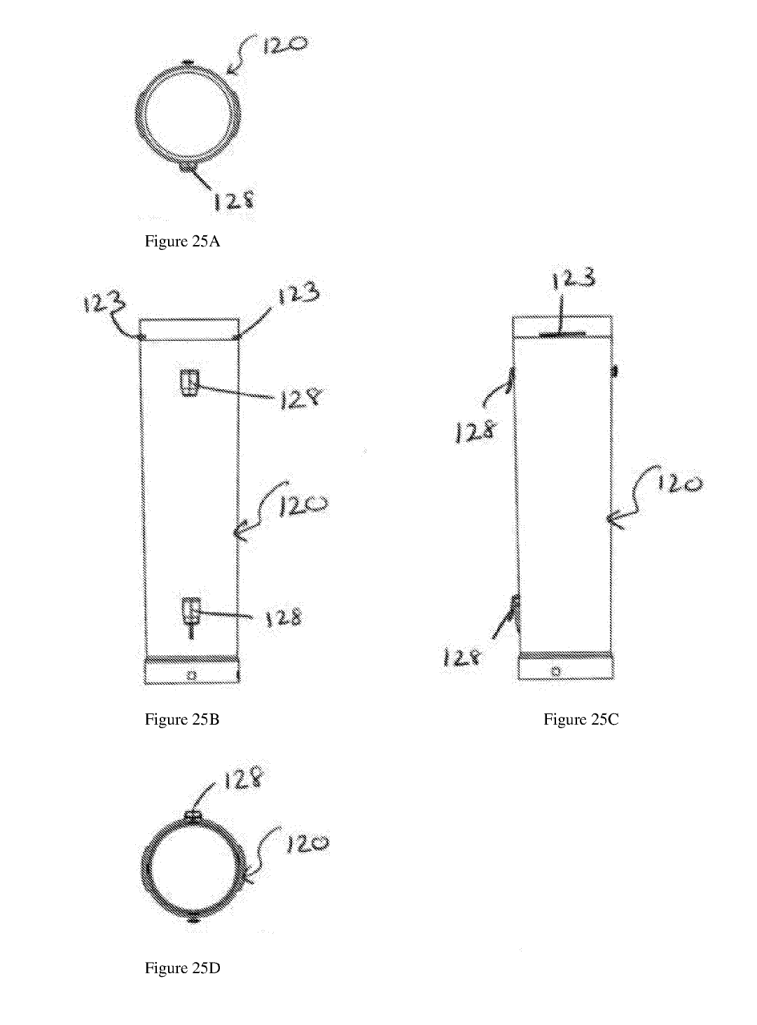

During a typical installation in a poultry house, the housing 120 is desirably positioned above ground level to ensure that the trough 160 is positioned within easy access of fowl roaming the poultry facility. As discussed, the drinker assembly 100 relies on flow of the drinking liquid under the effect of gravity for flow of the liquid from the housing 120 to the trough 160. The orientation of the housing 120 relative to the trough 160 is therefore of substantial importance. In order to maintain gravitational flow of the liquid from the housing, the housing 120 needs to be positioned at an elevated position relative to the trough 160. It is also important to ensure that the housing 120 is adequately supported at the elevated position. Advantageously, the tubular portion 124 comprises mounting hooks 128 that are integrally moulded into the outer walls of the tubular portion 124 thereby alleviating the need for additional metallic brackets or other non-integral mounting arrangements. Turning to FIGS. 25 to 27, two spaced apart mounting hooks 128 are provided along a length of the tubular portion 124. Each hook 128 is advantageously connected to the outer wall of the tubular portion 124. At two distinct connecting positions as clearly shown in FIG. 27. The hook 128 comprises a receiving portion 127 that together with a small part of the outer wall of the tubular portion 124 receives a supporting fixture mounted on a wall or a pillar and thereby mounts the housing 120 onto the supporting fixture. The hook 128 also includes a free end which extends outwardly and is curved or bent outwards away from the walls to enable easy mounting and dismounting of the housing 120. In some other alternative embodiments, other types of fasteners or fastening mechanisms may also be integrally moulded with the outer walls of the housing 120 for mounting the housing on supporting fixtures as described herein. Providing integrally formed hooks 128 thus enables easy installation of the drinker assembly 100 whilst also preventing the use of additional externally mounted brackets.

The housing 120 is also provided with a removable lid 126. During use of the drinker assembly 100, the housing may often need to be replenished with additional drinking liquid or other nutrients or medication. The lid 126 not only enables easy access of the housing 120 but also assists in prevents the ingress of dirt, grime germs etc. into the liquid contained in the housing. The lid 126 is operable to be locked in position with the housing 120 by way of a locking mechanism. The locking mechanism comprises two circumferentially spaced flanges 125 on the lid 126. Projecting notches 123 that are also correspondingly spaced apart along the circumference of a top portion of the tubular walls 124 and are configured to inter-engage with the flanges 125 to define a locked configuration of the housing 120. Typically the flanges 125 are slightly resilient in nature so that a pushing force applied on the lid 126 is sufficient to ensure a secure engagement between the respective notches 123 and the flanges 125. In order to remove the lid 126, a pulling force would be required to overcome the opposing force provided by the resilient flanges 125. Pulling the lid 126 disengages the respective notches 123 from the flanges 125. In order to assist with the unlocking of the lid 126, a handle 128 is also positioned on an outer surface of the lid 126 in order to assist with the opening of the lid 126. The handle 128 may be provided with ergonomic surface for receiving a user's hand for enabling easy removal of the lid 126.

In order to assemble the housing 120 before commencing use, the housing 120 needs to be assembled by coupling the base 122 with the tubular portion 124. The base 122 is provided with a connecting portion which includes an upstanding connecting rim 135. The rim 135 is positioned for alignment and engagement with a skirted end 131 of the tubular portion 124 thereby coupling the base 122 with the wall portion 124. Four circumferentially spaced locking projections 134 are provided on the connecting rim that are adapted to be received in correspondingly positioned locking apertures 132 provided on the skirted end 131. The locking projections 134 are arranged around the connecting rim 135 in a configuration such that the angular spacing in between the locking projections 134 is unequal. This is clearly illustrated in FIG. 31 in which locking projections 134A-134D are circumferentially arranged such that the angular spacing in between locking projection 134D and 134B is not the same as the angular spacing in between locking projection. Such a configuration allows the base 122 and the wall portions 124 to be only coupled in one coupling orientation and ensures that a leak proof seal is established between the base 122 and wall portion 124.

Turning to FIG. 31 in particular, the connecting rim 135 is provided with a machined groove 137. An elastomeric sealing member in the form of a circular O-ring is positioned during coupling of the base 122 and the tubular portion 124 to further prevent any leakage of the drinking liquid from the housing 120. The groove on the connecting rim 135 provides a first sealing surface and the skirted end 131 that engages with the O-ring provides the second sealing surface. Upon coupling of the base 122 with the tubular portion 124, the O-ring is deformed when the respective sealing surfaces are brought together and this exerts a force against the mating surfaces equal to the force it takes to deform the elastomeric member. The areas of contact between the O-ring and the sealing surfaces surfaces (contact bands) act as a barrier to block the passage of the drinking fluid out of the housing 120.

In some embodiments, the supporting member comprises one or more fasteners for fastening the housing onto a supporting surface or a supporting structure. For example, the fastener may take the form of a hook or a clip that is adapted to mount the housing onto a supporting surface of a structure such as a wall. In other embodiments, the fastener may be adapted for mounting the housing onto other supporting structures such as a fence.

In some embodiments, the hook that is adapted to hook onto the supporting surface or the supporting structure thereby mounting the housing to the supporting surface or supporting structure, the hook including a receiving portion for receiving at least a part of the supporting structure or supporting surface.

Advantageously, the aforementioned hook may also comprise an end portion positioned at a free end of the hook-body wherein the end portion is flanged in an outward direction away from the upstanding wall of the container. Providing such an outwardly flanged configuration is particularly advantageous in that it enables the easy hooking and unhooking of the hook onto the supporting structure.

Whilst the drinker assembly described herein is particularly suited for fowl, a person skilled in the art would recognise that the drinker may be utilised for supplying water to other animals such as but not limited to dogs, cats, rabbits, guineapigs etc.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further including a housing for at least enclosing the pan, the housing including an opening positioned in between the pan and the hopper for allowing poultry and the like to access an internal space enclosed by the housing for consuming the feed retained in the pan, wherein at least one upstanding web is provided in the internal space of the housing and is positioned for limiting movement of poultry or the like during consumption of the feed retained in the pan.

2. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further including a housing for at least enclosing the pan, the housing including an opening positioned in between the pan and the hopper during use for allowing poultry and the like to access an internal space enclosed by the housing for consuming the feed retained in the pan, the feeder further comprising at least one upstanding retaining web extending upwardly relative to the pan and positioned adjacent the opening, the retaining web being provided in the internal space of the housing and being positioned for retaining the feed in the housing.

3. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further including a housing for at least enclosing the pan, the housing including an opening positioned in between the pan and the hopper during use for allowing poultry and the like to access an internal space enclosed by the housing for consuming the feed retained in the pan, a feed directing device for receiving the feed from the hopper and directing the received feed into the pan through a feed directing passage forming a feed outlet, wherein separation between the outlet and a bottom portion of the pan is selectively adjustable.

4. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further including a housing for at least enclosing the pan, the housing including an opening positioned in between the pan and the hopper during use for allowing poultry and the like to access an internal space enclosed by the housing for consuming the feed retained in the pan, wherein the base includes a hood extending outwardly from an outer wall of the housing and over the opening to the housing, the hood including an upturned peripheral edge for preventing ingress of any extraneous matter positioned or accumulated on the hood into the housing from the opening.

5. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further comprising a housing for at least enclosing the pan, the housing including an opening positioned in between the pan and the hopper during use for allowing poultry and the like to access an internal space enclosed by the housing for consuming the feed retained in the pan, a feed directing device positioned for receiving the feed from the hopper and directing the received feed into the pan, wherein the food directing device is configured to be coupled to the hopper and/or the housing in no more than one coupled orientation.

6. A feeder for feeding poultry and the like, the feeder comprising a base including a pan configured to receive and retain feed, a storage hopper positioned above the base during use for receiving and storing feed, said hopper being operable to dispense feed into the pan under the effect of gravity, the base further including a housing for at least enclosing the pan, the housing including an opening positioned in between the pan and the hopper during use for allowing poultry and the like to access an internal space enclosed by the housing for consuming the feed retained in the pan, wherein the housing is configured to be coupled to the hopper in no more than one coupled orientation.

7. A feeder for feeding poultry and the like, the feeder comprising a base including a pan configured to receive and retain feed, a storage hopper positioned above the base during use for receiving and storing feed, said hopper operable to dispense feed into the pan under the effect of gravity, the base further including a housing for at least enclosing the pan, the housing including an opening positioned in between the pan and the hopper during use for allowing poultry and the like to access an internal space enclosed by the housing for consuming the feed retained in the pan, and at least one fastener for fastening the housing and/or the storage hopper onto a support, wherein during use, the fastener maintains the housing and/or the storage hopper in a substantially vertical orientation relative to each other thereby allowing the hopper to dispense feed into the pan under gravity.

8. A drinker assembly for supplying drinking liquid to poultry or the like, the assembly comprising a reservoir including a base and upstanding walls, the base and the walls defining an internal volume for holding the liquid therein, an outlet port extending through said reservoir to allow the liquid to exit said reservoir under gravitational effect and be received into a receptacle, a valve assembly positioned in fluid communication with the outlet port for controlling flow of the liquid from the reservoir to the receptacle, at least one supporting member adapted to support said reservoir at an elevated position relative to the receptacle to enable flow of the liquid under gravitational effect from the reservoir to the receptacle wherein the supporting member is integrally formed with the upstanding walls of the reservoir.

9. A drinker assembly for supplying drinking liquid to poultry or the like, the assembly comprising a reservoir including a base and upstanding walls, the base and the walls defining an internal volume for holding the liquid therein, an outlet port extending through said reservoir to allow the liquid to exit said reservoir under gravitational effect and be received into a receptacle, a valve assembly positioned in fluid communication with the outlet port for controlling flow of the liquid from the reservoir to the receptacle, a removable lid for introducing the liquid into the reservoir and/or for accessing the internal volume of the reservoir, the assembly further comprising a locking mechanism operable for locking the lid onto the reservoir to prevent removal of the lid from the reservoir.

10. A drinker assembly for supplying drinking liquid to poultry or the like, the assembly comprising, a reservoir including a base and upstanding walls, the base and the walls defining an internal volume for holding the liquid therein, an outlet port extending through said reservoir to allow the liquid to exit said reservoir under gravitational effect and be received into a receptacle, a valve assembly positioned in fluid communication with the outlet port for controlling flow of the liquid from the reservoir to the receptacle and a removable lid for introducing the liquid into the reservoir and/or for accessing the internal volume of the reservoir wherein the lid comprises a handle for holding the lid during use.

11. A drinker assembly for supplying drinking liquid to poultry or the like, the assembly comprising a reservoir comprising a base portion and an upstanding wall portion, the base and the wall portions defining an internal volume for holding the liquid therein, an outlet port extending through said reservoir to allow the liquid to exit said reservoir under gravitational effect and be received into a receptacle, a valve assembly positioned in fluid communication with the outlet port for controlling flow of the liquid from the reservoir to the receptacle and wherein the base portion and the wall portion are configured to be aligned and coupled to each other in no more than one coupled orientation.

12. A drinker assembly for supplying drinking liquid to poultry or the like, the assembly comprising a reservoir comprising a base portion and an upstanding wall portion, the base and the wall portions defining an internal volume for holding the liquid therein, an outlet port extending through said reservoir to allow the liquid to exit said reservoir under gravitational effect and be received into a receptacle a valve assembly positioned in fluid communication with the outlet port for controlling flow of the liquid from the reservoir to the receptacle and an elastomeric sealing member such that during coupling of the base portion with the wall portion, respective sealing surfaces provided thereon engage with the elastomeric sealing member thereby securing a leak proof seal between the base portion and the wall portion of the reservoir.
